(19) United States
(12) Patent Application Publication
(10) Pub. No.: US 2015/0300700 A1
(43) Pub. Date: Oct. 22, 2015

(54) A Compact Heat Exchanger for a Heat Pump

(71) Applicant: THERMOLIFT, INC., Stony Brook, NY (US)

(72) Inventor: Peter Hofbauer, West Bloomfield, MI (US)

(21) Appl. No.: 14/443,322

(22) PCT Filed: Nov. 25, 2013
(86) PCT No.: PCT/US13/71766

§ 371 Date: May 15, 2015

Related U.S. Application Data
(60) Provisional application No. 61/731,496, filed on Nov. 30, 2012.

(51) Int. Cl. F25B 13/00; B23P 15/26

(52) U.S. Cl. CPC F25B 13/00; B23P 15/26

(57) ABSTRACT

A Vuilleumier heat pump is disclosed in which the hot and cold displacers are disposed with a cylinder wall and an annular space outside the cylinder wall and inside the outer housing has at least one heat exchanger disposed therein. Any volume in the annular space is dead volume. A compact, effective heat exchanger is disclosed that facilitates reducing the dead volume. The heat exchanger is substantially helical with tubes that have a cross section that have a length in the direction of flow between adjacent tubes greater than a length perpendicular to the direction of flow.

### FIELD

The present disclosure relates to a compact heat exchanger for a heat pump.

### BACKGROUND

A Vuilleumier heat pump is disclosed in PCT application PCT/US2013/036101, filed 11 Apr. 2013, and entitled Heat Pump With Electromechanically-Actuated Displacers, which is incorporated herein in its entirety. In the interior of the heat pump are: a working volume in which the displacers are disposed; and dead volumes, which includes volumes in which heat exchangers and recuperators are disposed. The cycle efficiency of the heat pump decreases as the ratio of the dead volume to the working volume increases. Thus, it is desirable to reduce the dead volume as much as practical.

### SUMMARY

To overcome at least one problem in prior systems, a heat pump is disclosed in which a highly effective heat exchanger is provided to facilitate a low dead volume, thereby improving cycle efficiency. In one embodiment the heat pump has a housing having an outer wall and a cylinder liner within the housing, with an annular volume located inside the outer wall and outside the cylinder liner. The heat pump has a hot displacer disposed within the cylinder liner, a cold displacer disposed within the cylinder liner, a first heat exchanger disposed in the dead volume. The first heat exchanger has at least a first tube wrapped into a first coil with a plurality of turns with adjacent turns separated by a first predetermined distance.

The heat pump may also have a second heat exchanger disposed in the annular volume. The second heat exchanger has a second tube wrapped into a second coil with a plurality of turns with adjacent turns separated by a second predetermined distance.

The first and second tubes are substantially flat in portions of the cross section of the tube proximate an adjacent tube.

The first predetermined distance is a distance at which substantially laminar flow prevails between adjacent turns of the first coil and the second predetermined distance is a distance at which substantially laminar flow prevails between adjacent turns of the second coil.

The first and second predetermined distances are based at least on: the working fluid within the housing, temperature range expected to be encountered during operation of the heat pump, and velocity of a working fluid through a space between adjacent coils.

An inlet of the first tube and an outlet of the first tube pierce the housing and a liquid is pumped through the first tube.

The at least a first tube has multiple tubes that form parallel helixes with adjacent turns separated by the predetermined distance.

Also disclosed is a method to manufacture a heat pump, including: forming a cylinder, forming a cylindrical portion of the housing, forming hot and cold ends of the housing, defining openings in the cylindrical portion of the housing, extruding tubing having a cross-sectional shape that has two opposite parallel sides, turning the tubing to form one of a single and a double helix thereby forming a first heat exchanger, affixing the hot end of the housing to the cylindrical portion of the housing, inserting an annularly-shaped recuperator into the cylindrical portion of the housing, inserting the first heat exchanger into the cylinder, pushing an inlet end of the first heat exchanger out of a first opening in the housing, pushing an outlet end of the first heat exchanger out of a second opening in the housing, affixing the inlet end to the housing proximate the first opening, and affixing the outlet end to the housing proximate the second opening.

The method may further include assembling a displacer assembly, affixing the post onto the cold end of the housing, inserting the displacer assembly into the cylinder, and welding the cold end of the housing to the cylindrical portion of the housing.

The displacer assembly includes: a post with electromagnets coupled and first and second structures coupled thereto, a hot displacer, and a cold displacer.

The helix may be a double helix having first and second inlets and first and second outlets. The method may also include: affixing an inlet y-section to the first and second inlets with a single inlet portion of the inlet y-section coupling to the housing and affixing an outlet y-section to the first and second outlets with a single outlet portion of the outlet y-section coupling to the housing.

In one embodiment, a heat pump has a housing having an outer wall and a cylinder liner within the housing, with an annular volume located outside the cylinder liner and inside the outer wall, a hot displacer disposed within the cylinder liner, a cold displacer disposed within the cylinder liner, a first heat exchanger disposed in the annular volume wherein the first heat exchanger comprises at least a first tube wrapped into a first coil with a plurality of turns with adjacent turns separated by a first predetermined distance, and a second heat exchanger disposed in the annular volume wherein the second heat exchanger comprises at least a second tube wrapped into a second coil with a plurality of turns with adjacent turns separated by a second predetermined distance.

The first and second predetermined distances are less than a distance in which laminar flow exists for flow between adjacent turns of the first and the second tubes, respectively.

The first and second predetermined distances are determined so that flow between adjacent turns is predominantly laminar flow for a majority of operating parameters for which the heat exchanger is designed.

The outer wall has first, second, third, and fourth openings. The at least first tube has an inlet that passes through the first opening and an outlet that passes through the second opening. The at least second tube has an inlet that passes through the third opening and an outlet that passes through the fourth opening.

The heat pump may further have a first actuator proximate the hot displacer and a second actuator proximate the cold displacer. When the first actuator moves the hot displacer, the working fluid flows over the first heat exchanger and when the second actuator moves the cold displacer, working fluid flows over the second heat exchanger.

The heat pump may further include a liquid pump disposed outside the housing and coupled to the inlet of the first heat exchanger. The liquid pump is adapted to circulate a liquid through the first heat exchanger.

The tubes in the heat exchangers are substantially flat in portions adjacent to other tubes.

The tubes in the heat exchangers are substantially race-track shaped in cross section or substantially rectangular in cross section.

The at least first tube includes first and third tubes arranged in a double helix. The at least second tube includes second and fourth tubes arranged in a double helix. The first and third tubes form a y at both the inlet and outlet ends of the first heat exchanger and the second and fourth tubes form a y at both the inlet and outlet ends of the second heat exchanger.

### BRIEF DESCRIPTION OF THE DRAWINGS

FIG. 1 is a cross-sectional drawing of a Vuilleumier heat pump;

FIGS. 2A-D are schematic illustrations of a Vuilleumier-type heat pump shown in extreme positions of a cycle in which the heat pump may be operated;

FIG. 3 is a portion of a heat pump in cross section;

FIG. 4 is a cross section of a tube for a heat exchanger according to an embodiment of the disclosure;

FIGS. 5 and 6 are two embodiments of cross sections showing a portion of a cylindrical portion of the housing showing an embodiment with y-sections to accommodate dual helical tubes;

FIG. 7 is a cross section of a portion of a heat pump showing a double helical tubes; and

FIG. 8 is a flowchart showing one embodiment of a method to assemble a heat pump.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

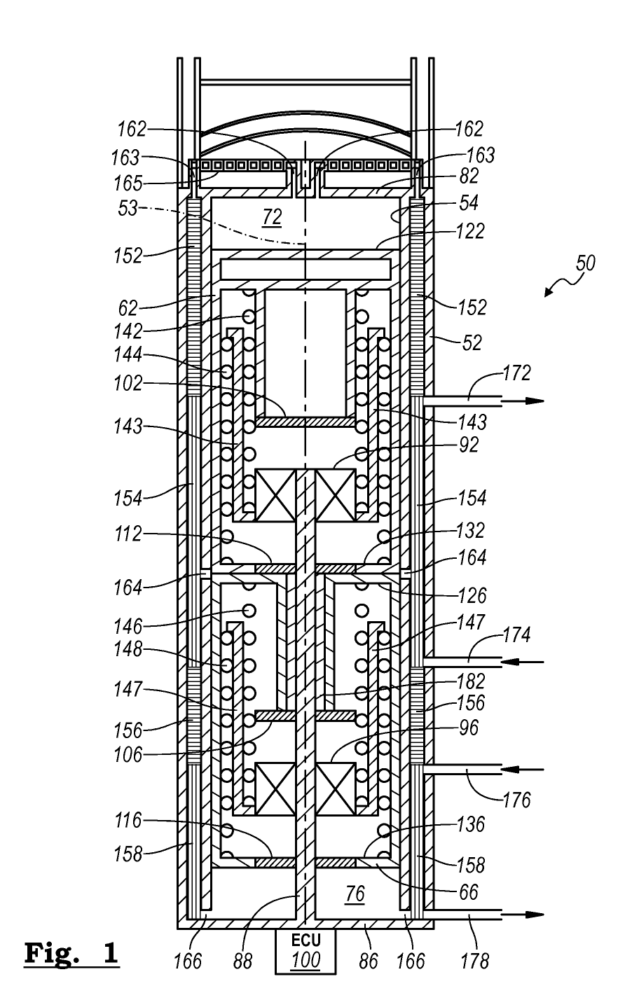

In FIG. 1, a Vuilleumier heat pump 50 has a housing 52. A cylinder wall 54 is provided in housing 52. A hot displacer 62 and a cold displacer 66 are disposed within cylinder wall 54. The displacers define three chambers: a hot chamber 72, a warm chamber, and a cold chamber 76. With the positions of displacers 62 and 66 as illustrated in FIG. 1, the warm chamber has no volume and thus is not visible in FIG. 1. Housing 52 has a hot end 82 and a cold end 86.

A post 88 is affixed to cold end 86 of housing 52 and extends into housing 52 along a central axis 53 of housing 52. Post 88 extends through a cold cap 136 and a hot cap 126 of cold displacer 66 and extends through a cold cap 132 of hot displacer 62. Post 88 has a first electromagnet 92 disposed within hot displacer 62 and a second electromagnet 96 disposed within cold displacer 66. Electromagnets 92 and 96 are affixed to post 88, but are disposed within hot displacer 62 and cold displacer 66, respectively. Displacers 62 and 66 move relative to their respective electromagnet.

Two ferromagnetic blocks 102 and 112 are affixed to hot displacer 62 with electromagnets 102 and 112 displaced from each other in a direction along the axis of housing 52. Two ferromagnetic blocks 106 and 116 are affixed to cold displacer 66 and displaced from each other in a direction along the central axis 52. Hot displacer 62 and cold displacer 66 both have a cylindrical wall coupled to top caps 122, 126 and bottom caps 132, 136, respectively. The top and bottom caps may be alternatively called hot and cold caps, respectively. The terms top and bottom or upper and lower refer to the arrangement illustrated in the figures and do not limit the present disclosure to a particular orientation.

Post 88 includes two electromagnets 92 and 96 with electromagnet 92 acting upon ferromagnetic blocks 102 and 112 and electromagnet 96 acting upon ferromagnetic blocks 106 and 116, as will be described in more detail below. A substantially cylindrical structure 143 is coupled to the periphery of electromagnet 92. A spring 142 is coupled between a cap 122 of hot displacer 62 and a portion of structure 143 proximate electromagnet 92. Another spring 144 is coupled between bottom cap 132 of hot displacer 62 and structure 143. Both of springs 142 and 144 are in compression, but the forces are balancing. If hot displacer 62 were to be pulled upward, the compression in spring 142 would be increased and the compression in spring 144 would be decreased such that there is an unbalanced force pulling hot displacer 62 downward to a neutral position.

Similarly, cold displacer 66 has internal springs 146 and 148. Electromagnet 96 has a substantially cylindrical structure 147 coupled to its periphery. Spring 146 is coupled between structure 147 and top cap 126 and spring 148 is coupled between structure 147 and bottom cap 136.

Hot displacer 62 has an extension 182 that extends into an opening in lower displacer 66 with the length of extension 182 being such that it is always coupled with lower displacer 66 regardless of the relative positions of the displacers.

Referring now to FIG. 1, housing 52 has openings 172 and 174 that are fluidly coupled to warm heat exchanger 154. A fluid, such water, can be supplied to warm exchanger 154 on the other side of the heat exchanger from the working fluid that is included within housing 52. Opening 172 can be the inlet for a cross flow heat exchanger and opening 174 can be the inlet for a parallel flow heat exchanger. Such a configuration is for providing heating. The heat pump may be operated for cooling purposes. Openings 176 and 178 are provided through housing 52 to provide access to cold heat exchanger 158.

An ECU 100, located external to housing 52, is electrically coupled to electromagnets 92 and 96. In the position of displacers 62 and 66 shown in FIG. 1, electromagnet 92 is not near blocks 102 or 112 and electromagnet 96 is not near blocks 106 or 116. Electromagnets 92 and 96 are used to move displacers 62 and 66 by pulsing electromagnets 92 and 96. If pulsed at a resonant frequency, one of blocks 102 and 112 becomes sufficiently close to electromagnet 92 such that electromagnet 92 can grab the block and hold it.

The flow of the gas within the heat pump is now considered, referring to FIG. 1. Housing 52 has a cylinder 54 in which hot and cold displacers 62 and 66 reciprocate. Between an outer surface of cylinder 54 and an inner surface of housing 52, is an annular volume into which a hot recuperator 152, a warm heat exchanger 154, a cold recuperator 156 and a cold heat exchanger are disposed. A second warm heat exchanger 154 between the warm chamber and the cold recuperator 156 is optional. There are openings in cylinder 54 that allow for the flow of gases between inside and outside the cylinder. The system includes:
passages 162 that fluidly couple hot chamber 72 with heat exchanger 165;
passages 163 that fluidly couple the annular space between cylinder 54 and housing 52 with heat exchanger 165;
openings 164 that fluidly couple warm chamber (not shown in FIG. 1 due to the position of the displacers, but is the volume that can exist between the displacers) with warm heat exchanger 154; and
openings 166 that fluidly couple cold chamber 76 with the annular volume at a location below cold heat exchanger 158.

Housing 52 and cylinder liner 54 are substantially cylindrical and have a common central axis in one embodiment and, thus, the volume between them is called the annular volume. In FIG. 1, the displacers are shown in a neutral position, i.e., the position at which the springs coupled to the displacers are in balance without any additional external forces. When the displacers are moved away from this position, there is a spring force acting on the displacers urging them toward the neutral position.

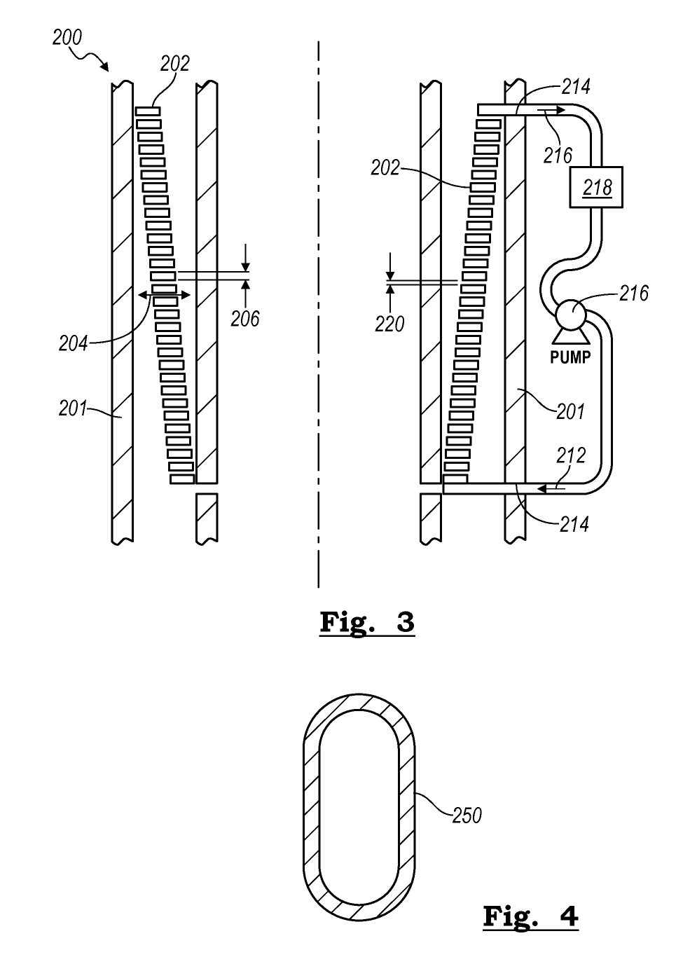

In operation, the displacers are moved by actuators. The cycle is shown, starting in FIG. 4A, with both displacers in an upward position. Hot displacer 62 is held (against spring force) in its upper position by electromagnet 92 holding onto ferromagnetic block 112. Cold displacer 66 is held in its upper position by electromagnet 96 holding onto ferromagnetic block 116.

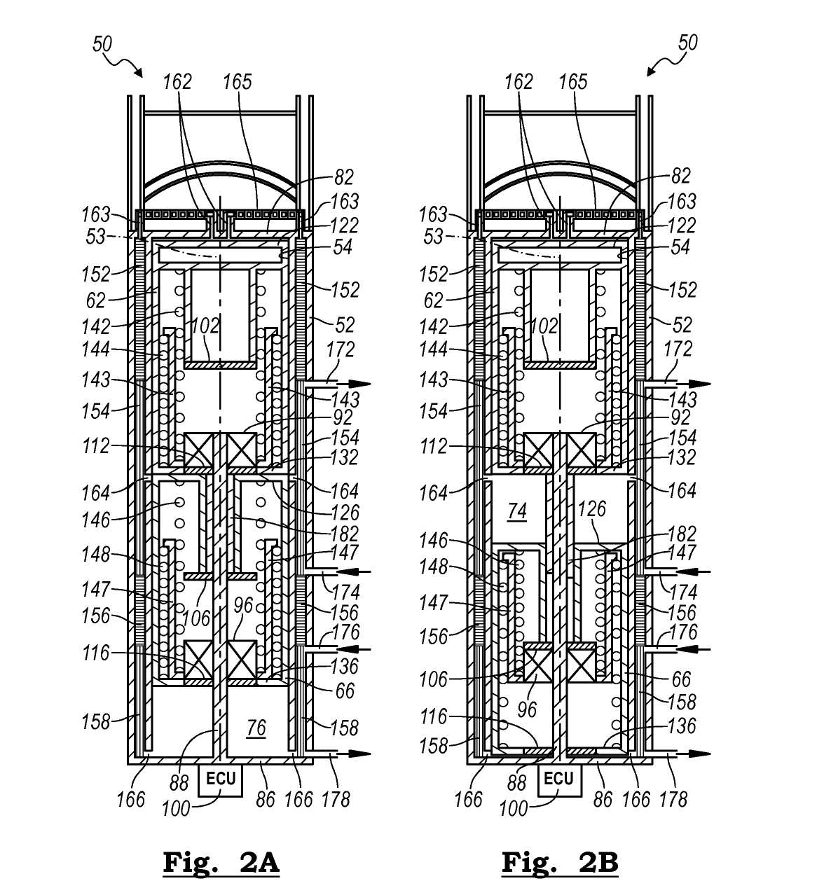

When electromagnet 96 is deactivated, springs 146 and 148 coupled to cold displacer 66 causes cold displacer to move downwardly past the neutral position toward its lower position. Electromagnet 96 is actuated and attracts ferromagnetic block 106. The situation in which hot displacer 62 is at its upper position and cold displacer 66 is at its lower position is shown in FIG. 2B.

In FIG. 2C, displacers 62 and 66 are both shown in their lower position. Hot displacer 62 moves from its upper to its lower position when electromagnet 92 is deactivated. Springs 142 and 144 act upon hot displacer 62 to move toward its lower position. Electromagnet 92 is activated to grab ferromagnetic block 102.

In FIG. 2D, displacers 62 and 66 are both returned to the initial state to complete the cycle. That is, displacers 62 and 66 in FIG. 2D are in the same position as in FIG. 2A. This occurs by deactivating both electromagnets 92 and 96. Springs coupled to each of the displacers cause displacers 62 and 66 to move upwardly. Both of electromagnets 92 and 96 are activated to grab ferromagnetic blocks 112 and 116, respectively.

The motion of the displacers 62 and 66 causes working fluid within housing 52 to move in the annular volume. When cold displacer 62 moves downwardly, such as between FIGS. 2A and 2B, fluid that is in cold chamber 7 moves out passage 76 past heat exchanger 158, recuperator 156, and heat exchanger 154, and into warm chamber 74.

Between the cycle points represented in FIGS. 2B and 2C, hot displacer 66 moves downwardly which causes the working fluid to flow out of warm chamber 74 through passage 164 pass heat exchanger 154, recuperator 152, through heat exchanger 165, and into hot chamber 72.

Between the cycle points represented in FIGS. 2C and 2D, displacers 62 and 66 both move upwardly causing the working fluid to leave hot chamber 72 and travel through the length of the annular volume and move into cold chamber 76.

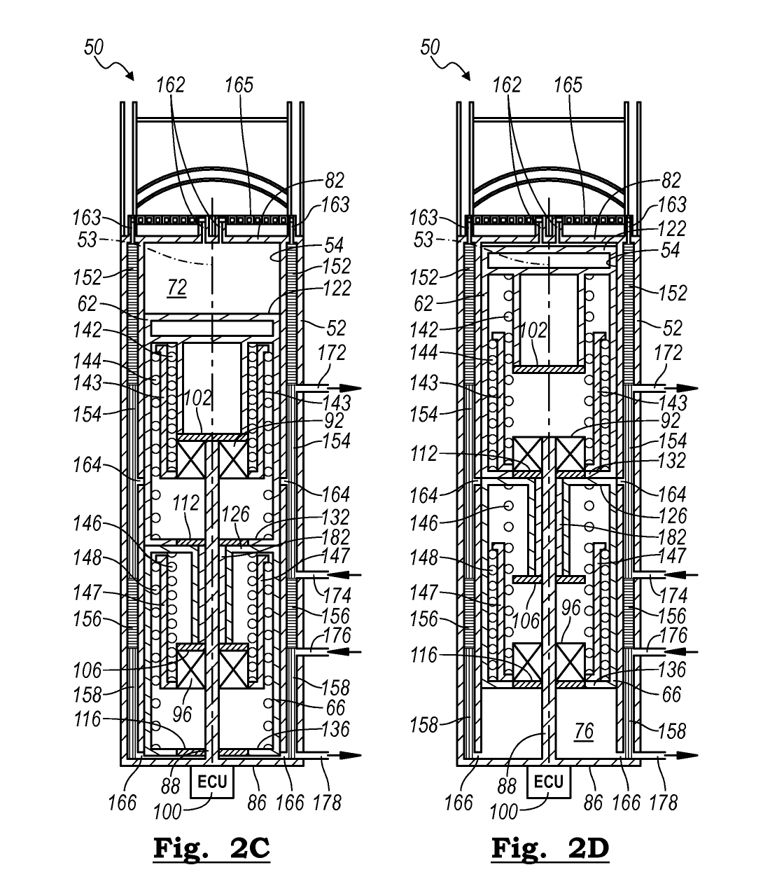

A portion of a heat pump 200 having a heat exchanger 202 is shown in FIG. 3 in cross section. A tube of substantially rectangular cross section is bent into a helix to form heat exchanger 202. The tube is longer in the direction of flow 204 between adjacent turns of the helix than in the other direction 206. A housing 201 of heat pump 200 has a first opening 210 through which the tube of heat exchanger 202 passes thereby serving as an inlet 212. Housing 201 also has a second opening 214 through which the tube of heat exchanger 202 passes thereby serving as an outlet 214. A liquid pump 216 is provided to cause flow of a liquid through heat exchanger 202. In some embodiments, heat pump 200 has two heat exchangers. Either of them can be represented by heat exchanger 202; thus only one is shown in FIG. 3, not both. A distance 220 between adjacent tubes is selected which causes the flow to be laminar. Besides distance, laminar flow is based on the working fluid and the temperature conditions expected to be encountered over the range of operation.

Referring to FIG. 1, the heat pump acts to heat the liquid when liquid is provided at 174 and exits at 172. The heat pump acts to cool the liquid when liquid is provided at 176 and removed at 178. The heat pump is used in one of the heating and cooling modes.

In FIG. 4, an alternative cross section 250 for the tube for the heat exchanger is substantially a race track, i.e., straight sides and rounded at the ends. The tube is wound such that the straight sides are adjacent to each other.

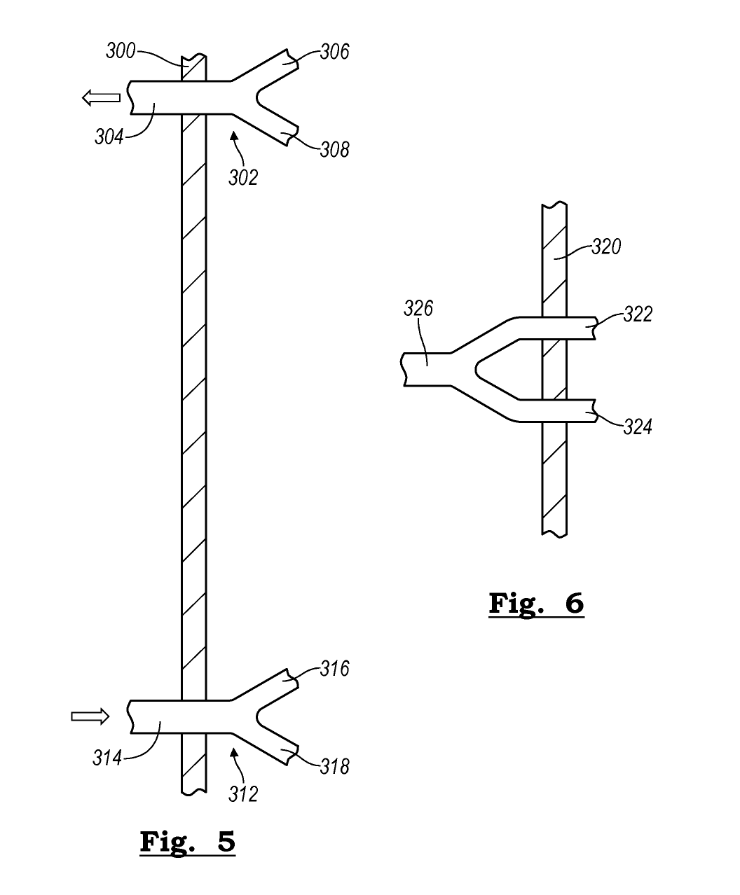

In the embodiment in FIG. 3, heat exchanger 202 is a helix formed out of a single tube having multiple turns. In some embodiments, pressure drop is too great for a single tube. In one alternative, a double helix is provided. In FIG. 5, housing 300 has two openings. Through one of the openings a y-section 302 is provided that has two passages 306 and 308 that combine to form a single outlet 304. A second y-section 312 serves as an inlet with one inlet tube 313 forking into two tubes 316 and 318.

In FIG. 6, an alternative y configuration is shown in which single tube 326 branches to form tubes 322 and 324. Each of tubes 322 and 324 pierce wall 320.

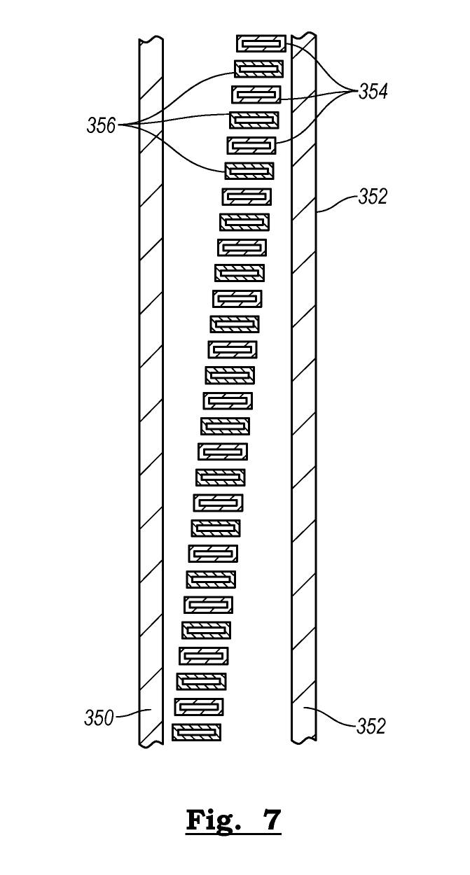

In FIG. 7, a cross section of a portion of a heat pump is shown having a housing 350 and a cylinder wall 352. Between the two is an annular space. Tube 354 is shown in cross section with sections of tube 356 interleaved with the sections of tube 354. The distance between adjacent tubes is the predetermined distance described above. Tubes 354 and 356 form a double helix. Alternatively, three or more tubes are used to form a triple (or greater) helix.

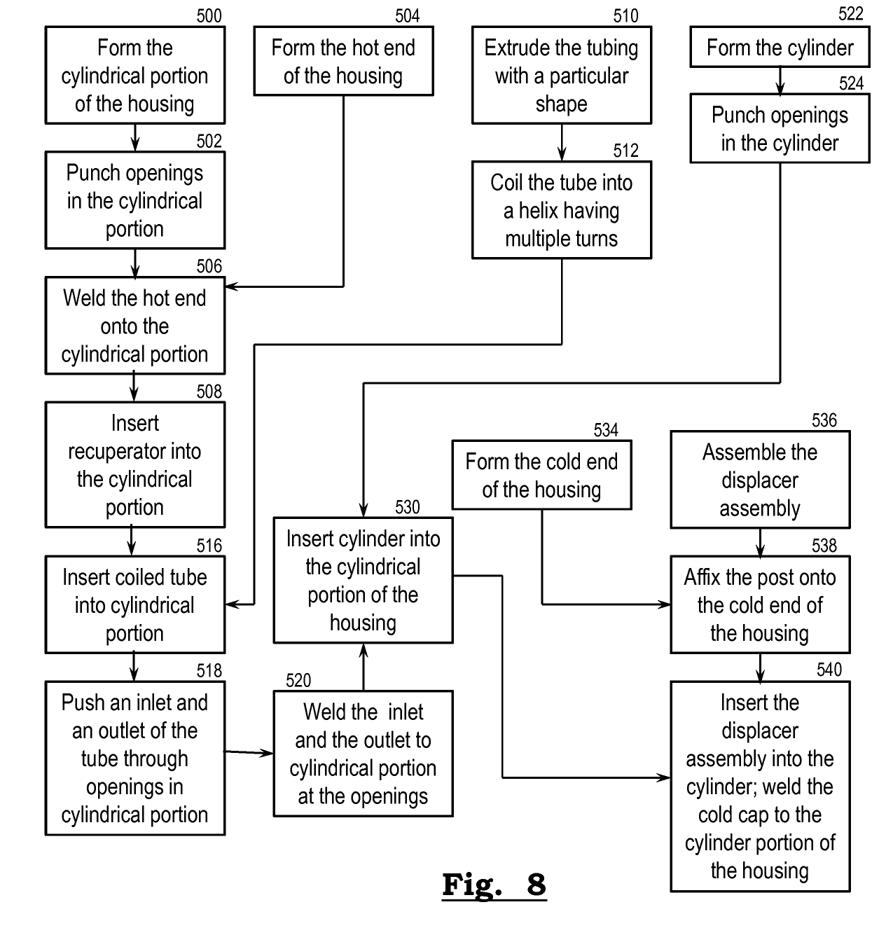

In FIG. 8, a flowchart showing one embodiment for assembling a heat pump. In block, 500 the cylindrical portion of the housing is formed. In block 502, openings are punched in the cylindrical portion (e.g., openings through which tubes 172, 174, 176, and 178 of FIG. 1 exit the housing). In block 504, the hot end of the housing is formed. In block 506, the hot end of the housing is welded onto one end of the cylindrical portion. In block 508, a recuperator is inserted in the cylindrical portion. In block 510, the tubing which is used to make the heat exchanger is extruded. The shape of the tube is longer in a first direction than in a direction perpendicular to the first direction. Furthermore, in the long direction the two sides are flat and parallel to each other. Non-limiting examples include a substantially rectangular cross section and a race-track cross section. In block 510, the tube is coiled into a helix having multiple turns. The helix is formed such that one of the flat parallel sides of one turn is adjacent a flat parallel side of another turn. Also, the distance between adjacent turns is less than a predetermined distance. In block 516, the coiled tube (helix) is inserted into the cylindrical portion of the housing. The inlet and outlet of the helical tube are pushed through the openings in the cylindrical portion of the housing in block 518. In bock 520, the inlet and outlet are welded to the cylindrical portion proximate the openings. The weld is such that it seals the housing at the openings. In block 522, the cylinder (cylinder 54 of FIG. 1) is formed and openings defined therein in block 524. The openings are, for example, openings 164 and 166 in FIG. 1. In block 530, the cylinder is inserted into the cylindrical portion of the housing. In block 536, the displacer assembly is assembled. The displacer assembly includes many elements including the post, the electromagnets, the springs, etc. In block 538, the post of the displacer assembly is affixed to the cold end of the housing. In block 540, the displacer assembly is inserted into the cylinder and the cold cap is welded to the open end of the cylinder portion of the housing.

In the flowchart in FIG. 8, block describing one heat exchanger and one recuperator are shown. However, in FIG. 1, the annular volume between the cylinder and the cylindrical portion of the housing has two recuperators and two heat exchangers. After block 520, an additional recuperator can be inserted in the cylindrical portion of the housing and then block 510, 512, 516, 518, and 520 are repeated for a second heat exchanger.

The assembly processes in FIG. 8 describes a number of welding processes. However, the components may alternatively be affixed via brazing, clamping with an appropriate sealant between surfaces such as flanges, or any suitable coupling techniques.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

1. A heat pump, comprising:
a housing having an outer wall and a cylinder liner within the housing, with an annular volume located inside the outer wall and outside the cylinder liner;
a hot displacer disposed within the cylinder liner;
a cold displacer disposed within the cylinder liner; and
a first heat exchanger disposed in the annular volume wherein the first heat exchanger comprises at least a first tube wrapped into a first coil with a plurality of turns with adjacent turns separated by a first predetermined distance wherein a cross-section of the at least first tube is one of substantially race-track shaped and substantially rectangular.

2. The heat pump of claim 1, further comprising:
a second heat exchanger disposed in the annular volume wherein the second heat exchanger comprises a second tube wrapped into a second coil with a plurality of turns with adjacent turns separated by a second predetermined distance.

3. The heat pump of claim 2 wherein the first and second tubes are substantially flat in portions of the cross section of the tube proximate an adjacent tube.

4. The heat pump of claim 2 wherein the first predetermined distance is a distance at which substantially laminar flow prevails between adjacent turns of the first coil and the second predetermined distance is a distance at which substantially laminar flow prevails between adjacent turns of the second coil.

5. The heat pump of claim 4 wherein the first and second predetermined distances are based at least on: the working fluid within the housing, temperature range expected to be encountered during operation of the heat pump, and velocity of a working fluid through a space between adjacent coils.

6. The heat pump of claim 1 wherein an inlet of the first tube and an outlet of the first tube pierce the housing and a liquid is pumped through the first tube.

7. The heat pump of claim 1 wherein the at least a first tube comprises multiple tubes that form parallel helixes with adjacent turns separated by the predetermined distance.

8. A method to manufacture a heat pump, comprising:
forming a cylinder;
forming a cylindrical portion of the housing;
forming hot and cold ends of the housing;
defining openings in the cylindrical portion of the housing;
extruding tubing having a cross-sectional shape that has two opposite parallel sides;
turning the tubing to form one of a single and a double helix thereby forming a first heat exchanger;
affixing the hot end of the housing to the cylindrical portion of the housing;
inserting an annularly-shaped recuperator into the cylindrical portion of the housing;
inserting the first heat exchanger into the cylinder;
pushing an inlet end of the first heat exchanger out of a first opening in the housing;
pushing an outlet end of the first heat exchanger out of a second opening in the housing;
affixing the inlet end to the housing proximate the first opening; and
affixing the outlet end to the housing proximate the second opening.

9. The method of claim 8, further comprising:
assembling a displacer assembly including: a post with electromagnets coupled and first and second structures coupled thereto, a hot displacer, and a cold displacer;
affixing the post onto the cold end of the housing;
inserting the displacer assembly into the cylinder; and
welding the cold end of the housing to the cylindrical portion of the housing.

10. The method of claim 8 wherein the helix is a double helix having first and second inlets and first and second outlets, the method further comprising:
affixing an inlet y-section to the first and second inlets with a single inlet portion of the inlet y-section coupling to the housing; and
affixing an outlet y-section to the first and second outlets with a single outlet portion of the outlet y-section coupling to the housing.

11. A heat pump, comprising:
a housing having an outer wall and a cylinder liner within the housing, with an annular volume located outside the cylinder liner and inside the outer wall;
a hot displacer disposed within the cylinder liner;
a cold displacer disposed within the cylinder liner;
a first heat exchanger disposed in the annular volume wherein the first heat exchanger comprises at least one tube wrapped into a helical coil with a plurality of turns wherein adjacent turns are separated by a first predetermined distance; and
a liquid pump disposed outside the housing and fluidly coupled to the inlet of the first heat exchanger, the liquid pump adapted to circulate a liquid through the first heat exchanger.

12. The heat pump of claim 11 wherein the at least one tube comprises first, second, and third tubes; and each coil of the second tube is adjacent to a coil of the first tube and a coil of the third tube.

13. The heat pump of claim 11, further comprising:
a second heat exchanger disposed in the annular volume wherein the second heat exchanger comprises at least a second tube wrapped into a second coil with a plurality of turns with adjacent turns separated by a second predetermined distance.

14. The heat pump of claim 13 wherein the first and second predetermined distances are less than a distance in which laminar flow exists.

15. The heat pump of claim 13 wherein the outer wall has first, second, third, and fourth openings; the at least first tube has an inlet that passes through the first opening and an outlet that passes through the second opening; and the at least second tube has an inlet that passes through the third opening and an outlet that passes through the fourth opening.

16. The heat pump of claim 13, further comprising:
a first actuator proximate the hot displacer; and
a second actuator proximate the cold displacer wherein when the first actuator moves the hot displacer, the working fluid flows over the first heat exchanger and when the second actuator moves the cold displacer, working fluid flows over the second heat exchanger.

17. (canceled)

18. The heat pump of claim 11 wherein the tubes in the heat exchangers are one of substantially race-track shaped in cross section and substantially rectangular in cross section.

19. The heat pump of claim 13 wherein the at least first tube comprises first and third tubes arranged in a double helix and the at least second tube comprises second and fourth tubes arranged in a double helix.

20. The heat pump of claim 19 wherein the first and third tubes form a y at both the inlet and outlet ends of the first heat exchanger and the second and fourth tubes form a y at both the inlet and outlet ends of the second heat exchanger.

21. The heat pump of claim 11 wherein the at least one tube is substantially flat in portions of the cross section of the tube proximate an adjacent turn.
